(19) United States
(12) Patent Application Publication
(10) Pub. No.: US 2010/0301567 A1
(43) Pub. Date: Dec. 2, 2010

(54) WELDED METAL SEAL

(76) Inventor: Klaus Schmitt, Grunebach (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/738,331

(22) PCT Filed: Jun. 25, 2008
(86) PCT No.: PCT/EP08/05162

§ 371 Date: Aug. 18, 2010

(30) Foreign Application Priority Data
Oct. 18, 2007 (DE) 10 2007 049 925.8

(51) Int. Cl. F16J 15/08; B23K 11/00

(52) U.S. Cl. 277/654; 277/650; 219/148

(57) ABSTRACT

The invention discloses a metal seal with a seam, wherein the metal seal has at least one sealing regions which is delimited on two sides by a respective boundary in order to be in seal-forming contact with at least one corresponding sealing surface, wherein the seam is provided with at least one weld seam, which is characterized in that each weld seam extends only outside the boundaries of at least one sealing region, such that he metal seal at eh seam between the boundaries of at least one sealing region is unwelded over the entire thickness of the seam.

The present invention pertains to seals. The present invention specifically pertains to metallic seals. The present invention also pertains to metallic seals of materials that are resistant to high temperatures. The present invention furthermore pertains to non-seamless metallic seals that are produced of wire or band material.

Until now, it is common practice to either punch such seals out of solid material or to form a ring of wire or band material that is welded into a ring seal at a joint.

Known metallic seals are described, for example, in American patent applications U.S. 2006/0237963 “Seal for forming a brazed joint” by G. Moore and U.S. 2004/0239053 “Seal” by Rowe et al.

Seals of this type that are produced of band material bent into a ring usually have the disadvantage that leaks can occur at the location, at which the ring seal was closed by means of a welding seam. The alternative solution of producing such seals of shaped flat material is also not practical because excessive scrap is created.

The present invention therefore is based on the objective of providing a metallic seal, in which the known disadvantages of high costs and the risk of leaks are eliminated.

According to a first aspect of the present invention, a metallic seal with a seam, i.e., an at least partially non-seamless metallic seal, is provided. In this case, the metallic seal features at least one sealing area in order to contact at least one corresponding sealing surface in a sealing fashion. At least one sealing area is respectively defined by a boundary on two sides in this case. At the seam, the inventive metallic seal is provided with a welding seam that respectively extends or extend outside the boundaries of at least one of the sealing areas only, wherein the metallic seal is unwelded at the seam between the boundaries of at least one sealing area over the entire thickness of the seam.

It should be noted that the unwelded seam extends into the at least one sealing area in the inventive seal. No welding seam that closes the seam or connects the ends of the seal extends in the sealing area or on the edge. The peculiarity of the inventive metallic seal can be seen in that the seal features a (closed) gap (or an unwelded, but “gapless” joint) instead of a welding seam at the critical location of the sealing area.

According to another aspect of the present invention, a method for producing an inventive metallic seal is provided.

The metallic seal features a seam and at least one sealing area that is intended for contacting at least one corresponding sealing surface in a sealing fashion. At least one of the sealing areas is arranged on an edge of the seal in this case. The seam is provided with a welding seam, wherein the welding seam ends before the edge, on which a sealing area is arranged. In addition, the welding seam extends outside the sealing area arranged on the edge of the seal only.

The inventive method comprises the step of providing a semi-finished band or wire material. The semi-finished band or wire material is cut into at least one blank such that each blank features end regions or cut faces. The blank is shaped in such a way that at least two end regions (of one or more blanks) respectively abut one another and form a seam. The blanks are shaped such that at least one sealing area is arranged on the blanks, wherein the sealing area is defined by boundaries. The blanks are thusly welded into a seal in such a way that the welding seam or the welding seams extend(s) outside at least one sealing area only and end(s) before the boundaries of at least one sealing area. The seam of the metallic seal remains unwelded between the boundaries of a sealing area in this case.

It is proposed that the sequence, in particular, of the last three steps can be arbitrarily changed. However, the described sequence provides the advantage that the unwelded part of the joint cannot widen into a gap due to the subsequent processing steps. Depending on the type of subsequent processing steps, the gap can also be closed further by means of a corresponding shaping process.

The method preferably also comprises the step of roll-sizing the sealing area. Due to the roll-sizing, the sealing area can be realized in the form of a sealing surface, a sealing edge or a sealing lip. Roll-sizing also provides the advantage that the sealing area is compressed and therefore compacted and widened such that the two abutting unwelded areas of the seam are pressed against one another in a more powerful fashion and the tightness of the seal at the seam is improved.

The metallic seal is preferably provided with at least one bead (that may rise in the radial direction or in the axial direction).

Beads make it possible to produce seals with well definable contact pressures and/or adequate options for compensating sealing gaps that are variable, for example, due to widthwise thermal expansion.

It is preferred that the metallic seal essentially is at least partially shaped like a cylinder jacket.

Consequently, the seal extends at least partially perpendicular to a sealing gap, into which the seal is inserted.

The cylinder jacket is preferably realized in a barrel-shaped fashion. Due to the barrel shape, the seal is particularly well suited for sealing pressurized cavities of pipes or the like because a force component originating from the medium to be sealed presses a sealing area arranged on the “barrel edge” against the sealing surfaces. Another advantage of such a construction can be seen in that the seam on the unwelded part is compressed during the compression of such a seal between two sealing surfaces.

The cylinder jacket of the metallic seal is advantageously tapered. In such an embodiment, volumes can be sealed particularly well against a surrounding excess pressure. Depending on the design of the seal, it is possible to compress the seam by means of an externally acting excess pressure in this case.

The metallic seal is preferably provided with a surface coating. Surface coatings may be applied chemically, by means of electroplating or vapor-depositing, Chemical Vapor Deposition (CVD) or flame-spraying.

The metallic seal is preferably provided with a surface coating at least in the region of a sealing area. Surface coatings in the region of the sealing area may serve for improving the sealing properties of the seal. It is also possible to apply a surface coating onto the sealing area in order to enable the seal to shift relative to the sealing surface under a load. This can be achieved, for example, with an elastomer coating, a (soft or nonferrous heavy) metal coating or a carbon or graphite coating, respectively.

A surface coating may serve for improving the resistance of the seal to mechanical and/or chemical stresses. This can be achieved, for example, by means of nickel-plating or nitriding. Depending on the respective application, it is also possible to respectively use or apply several or different surface coatings (inside/outside, adjacently or on top of one another).

The surface coating preferably comprises a solder. The surface coating may comprise a solder and/or a flux. In high-temperature seals, in particular, this makes it possible for the seal to solder itself to the sealing surfaces in the temperature (not pressure) overload mode. Such an embodiment may also serve for quickly and easily constructing a bellow or a multipart seal.

The applied surface coating preferably improves the sealing properties of the sealing area and therefore of the entire seal.

The metallic seal is advantageously provided with at least one bead. A bead makes it possible to provide the metallic seal with an elastic property similar to a disk spring. Half beads and/or full beads make it possible to better adjust or define the surface pressures in the sealing area. In this case, the beads may extend in the circumferential direction and rise in the radial direction and/or axial direction.

The metallic seal is preferably provided with at least one bellow. The bellow may be realized in the form of a folding bellow, a disk or a corrugated bellow. In this case, the number of folds, discs or corrugations is not predefined. Bellow-type seals make it possible to achieve particularly uniform surface pressures and particularly large clearances for movements between the sealing surfaces (particularly in soldered seals).

The welding seam is preferably realized in the form of a laser welding seam. Laser welding seams can be produced in the form of particularly small welding seams without having to supply additional material.

The welding seam is preferably produced on one side. A welding seam produced on one side may be sufficient for achieving the desired sealing properties, particularly when using thin materials. A one-sided welding seam is advantageously produced on the side of the seal, on which predominantly tensile stresses occur. One-sided welding seams may also be produced on different sides of the seal, i.e., the one-sided welding seam can change sides. This makes it possible to optimize the diffusion of stresses in the seal. It is furthermore possible to adapt the course of the welding seam to the production process/sequence, for example, in order to avoid shifting of the seal during the welding process.

The welding seam may be advantageously produced on both sides of the seal, i.e., realized in a two-sided fashion. This may additionally increase the strength of the seal under high loads. In addition, a two-sided welding seam provides the advantage of subjecting the material to a reduced flame-straightening effect. With respect to two-sided welding seams, it can be assumed that notch effects are reduced such that the service life of the seal up to the expected failure can be extended.

The seam is preferably profiled. The seam or the end regions of the blanks may be respectively profiled in such a way that the seam is self-centering and/or self-clamping in order to improve the sealing properties of the unwelded part of the seam and/or to simplify the production of the seal. In this respect, the simplification concerns, in particular, the welding process and a possible roll-sizing step and not necessarily the cutting to length or the processing of the end regions. In this case, the profiling may extend in the plane of the seal and/or perpendicular to the plane of the seal.

The seam preferably is at least partially inclined relative to the metallic seal. This makes it possible to achieve that the critical areas of the seam do not lie opposite of one another for the price of a longer seam such that stresses or other inhomogeneities that are respectively caused by the seam or the welding seam [text missing].

The part of the seam situated in the sealing area, into which the welding seam does not extend, is advantageously compressed by forces that originate from the adjacent welding seam. Until now, this principle was only used in flame-straightening. During the cooling process, the welding seam thermally contracts after it solidifies and thusly presses adjacent unwelded end regions of the seam against one another.

The part of the seam of a sealing area, into which the welding seam does not extend, is preferably compressed by forces that act upon the installed seal. This can be realized, for example, with a conically tapered seal, in which the sealing edge (or the sealing area) is arranged on the tapered part of an envelope of the cone. If the seal or the envelope of the cone is subjected to a compression from above, the seam extending on the envelope of the cone is compressed.

Although the preceding description can be interpreted in such a way that sealing edges or edge areas of a metallic seal are provided with a partially unwelded seam, it is also possible to provide an unwelded area (for example, in the region of a full bead) that is bordered by a welding seam on both sides (for example, inside and outside).

The welding seam is preferably produced on the side of the seal, on which the sealing areas are also arranged.

A precision blanking method can preferably be used for producing the blank. A precision blanking method means that the cut is produced without fractured surface. The welding seam may furthermore be realized in the form of a laser welding seam. The welding seam may respectively stop or end, for example, 0.2 to 1 mm before the respective sealing point, sealing edge or sealing area. A sealing surface or a sealing edge is preferably produced in the sealing area in a metal-cutting or non-cutting fashion. If the sealing point is roll-sized in a last production step, the unwelded part of the gap can (also) be non-positively compressed such that the seal is also tight in the unwelded part of the gap (i.e., in the sealing area).

The seal preferably comprises at least two sealing areas that are respectively defined by boundaries. In such a seal, each welding seam extends outside the boundaries of at least the two sealing areas only. In this embodiment, the metallic seal respectively remains unwelded at the seam between the boundaries of the two sealing areas over the entire thickness. All above-described embodiments could, in principle, also be realized in the form of a disk-shaped end seals, for example, for sealing a pipe or a container. All above-described embodiments also could, in principle, be realized with several sealing areas, of which only one extends over an unwelded seam (embodiments of this type can be used for asymmetric sealing surfaces). The present embodiment with two sealing areas of the inventive design is particularly suitable for symmetric sealing surfaces.

In one embodiment, at least one of the sealing areas is arranged on an edge of the seal. In this embodiment, the edge that coincides with the boundaries of the sealing areas may also remain unwelded.

The metallic seal preferably is unwelded at the seam from the sealing area up to the edge over the entire thickness. If the sealing areas are arranged on the edge, it is not necessary to additionally reinforce the edge in this embodiment as long as the pressures to be sealed are not excessively high.

The seam of the metallic seal preferably is welded between a boundary of the sealing area and the edge. In this embodiment, the edge of the seal is (outwardly or inwardly) extended over the sealing area such that the seal is supported from both sides in the sealing area. This embodiment makes it possible to additionally reinforce the unwelded seam in the sealing area such that the inventive seal can also be used for higher pressures (than sealing areas welded on one side).

The invention is illustrated in the drawings in the form of two different embodiments of inventive metallic seals.

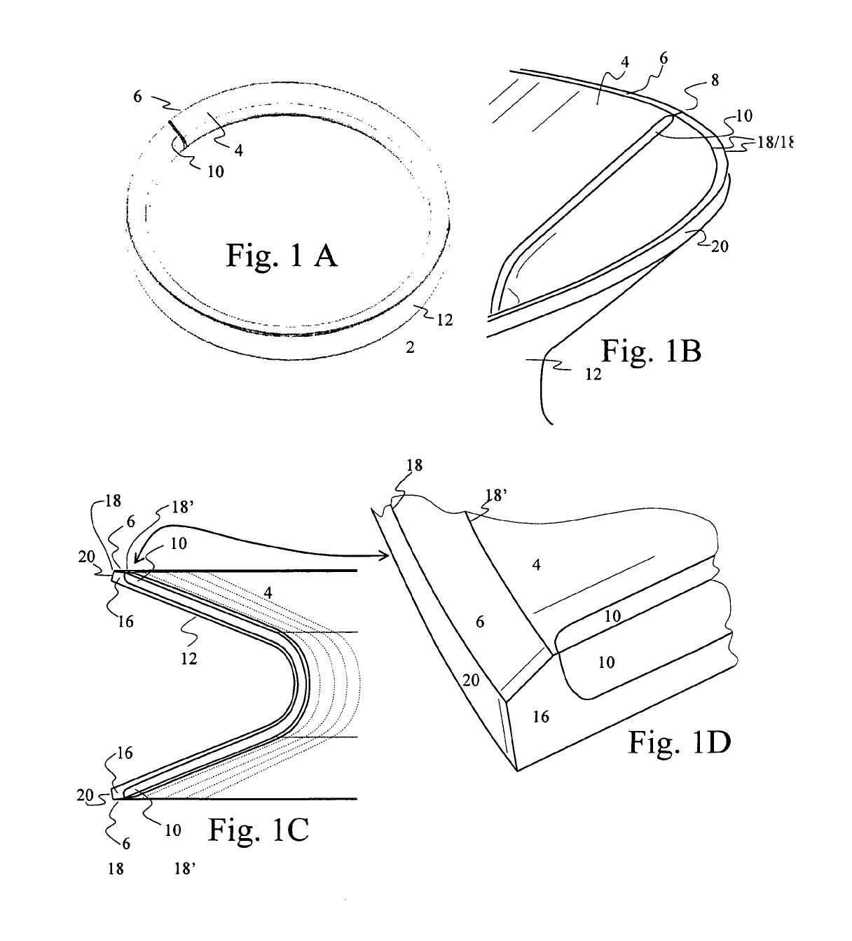

FIGS. 1A to 1D show different views of an embodiment of an inventive seal of essentially v-shaped cross section, wherein the opening of the cross section of the seal points outward.

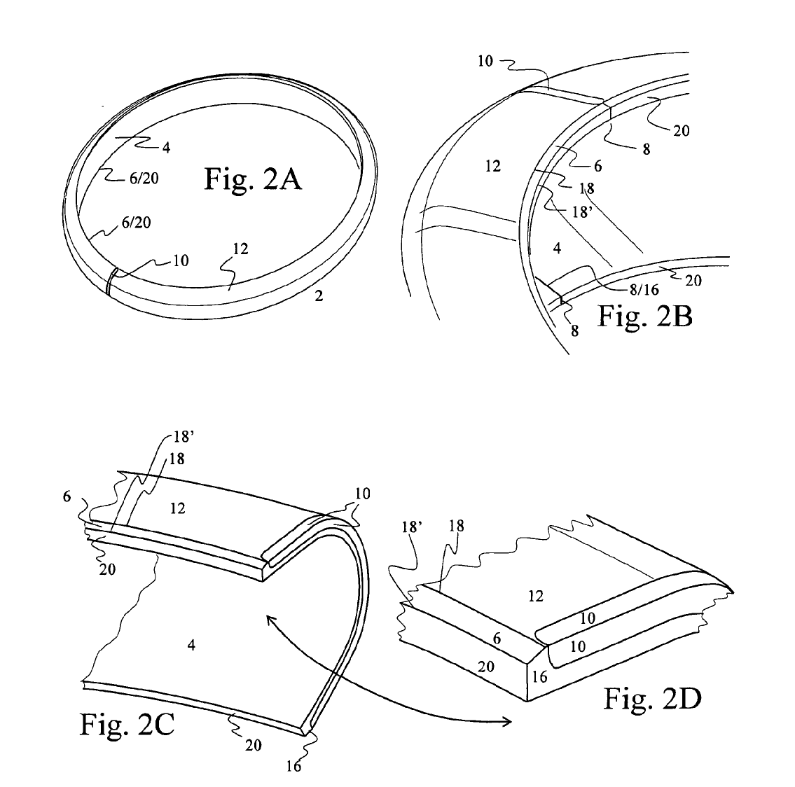

FIGS. 2A to 2D show an embodiment of an inventive seal of essentially u-shaped cross section, wherein the opening of the cross section points inward.

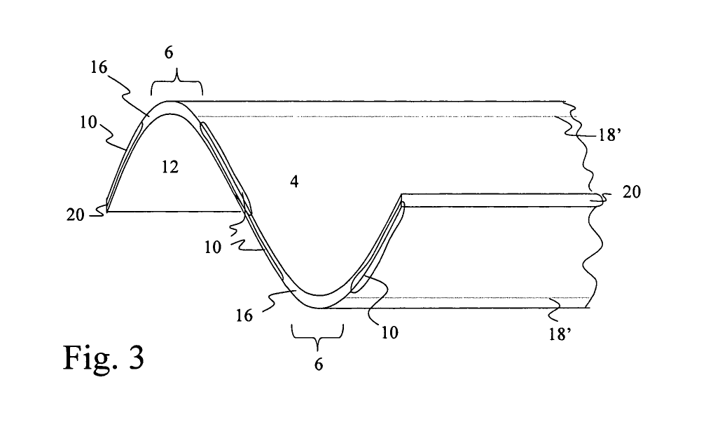

FIG. 3 shows a partially sectioned view of an embodiment of the seal, in which the sealing areas are not directly arranged on the edge of the seal.

The views A to D respectively represent a perspective oblique view, a detailed view, a sectioned view and a detailed sectioned view. The line of section of the sectioned views C and D respectively extends along the seam.

The seals illustrated in the figures are realized in the form of single-curved round seals that are produced of a metal sheet or strip and the edges of which respectively serve as sealing elements or sealing areas.

FIG. 1A shows a general view of a seal 2 with sealing areas 6 (sealing surfaces, sealing edges or sealing lips) that are directed outward in the axial direction. The outer side 12 of the seal that lies radially outward is curved inward in the axial direction. This means that the seal is tapered in the axial direction. The inner side 4 of the seal 2 that lies radially inward is convexly curved in the axial direction. The seal 2 therefore essentially forms part of a hyperboloid of one sheet. The seal 2 is produced of flat material that is bent into a ring. At a seam 8, the ring was closed by means of a welding seam 10. For reasons of clarification, it should be noted at this point that the designations inner side 4 and outer side 12 always refer to the radial direction (and not, e.g., the axial direction) in all exemplary embodiments illustrated in the figures.

The seal illustrated in FIG. 1A to 1D is particularly suitable for sealing cavities against external excess pressures as they occur, for example, in vacuum technology or in the construction of underwater installations.

FIG. 1A merely shows the welding seam 10 at the seam 8. Due to the scale, the course and the boundary of the welding seam 10 are shaped in such a way that it ends before a boundary 18′ of the sealing area 6 and also before the edge 20 of the seal 2.

FIG. 1B shows a detailed view of the seal, in which the seam 8 with the welding seam 10 is illustrated. FIG. 1B also shows the sealing area 6 that is realized in the form of a sealing surface on the edge 20 that is directed radially outward. The inner side 4 and the outer side 12 of the seal are also shown.

According to FIG. 1B, the welding seam or welding bead 10 ends before the (radially inner) boundary 18′ of the sealing area (sealing edge or sealing surface) 6. The welding seam or welding bead 10 also ends before the (radially outer) boundary 18 of the sealing area 6 that adjoins the edge 20. Due to this design, possibly occurring material changes such as recrystallizations or the like cannot affect the sealing area 6.

FIG. 1C shows a sectioned view of the seal illustrated in FIGS. 1A and 1B. The line of section of the sectioned view extends along the partially unwelded seam 8.

The sectioned view is slightly inclined from the inside referred to the seam 8. The seam 8 is divided into two areas, namely the welding seam 10 (the welded part of the seam 8) and the unwelded part 16 of the seam 8. Due to the viewing direction, part of the welding seam 10 extending on the inner side 12 of the seal 2 is also visible. The outer side 4 of the seal is only visible as a line in the section. The sealing areas 6 respectively extend from the (radially) inner boundaries 18′ up to the (radially) outer boundaries 18 of the seal. The sealing areas 6 also extend between the edges 20 and the inner side 12 of the seal 2. According to FIG. 1C, the welding seam 10 does not extend into the sealing areas 6, but rather only up to the inner boundaries 18′. The radially outer boundaries 18, as well as the edges 20 of the seal, remain unwelded in FIG. 1C.

FIG. 1D shows an enlarged detailed view of FIG. 10. FIG. 10 shows that the welding seam 10 does not extend up to the sealing area 6. FIG. 1D clearly shows that the welding seam 10 ends before the inner boundary 18′ of the seal 2. The unwelded part 16 of the seam extends in the sealing area 6 and to the edge 20 of the seal in this case. Due to the chosen perspective of the detail, only the inner side of the seal is illustrated in the form of a surface.

FIG. 2A shows a general view of a seal 2 of essentially u-shaped cross section. The seal 2 is essentially realized in a barrel-shaped fashion. The seal 2 has a concave inner side 4 and a convex outer side 12. The metallic seal is provided with edges 20 that are directed (radially) inward and adjacent to which sealing areas 6 realized in the form of sealing surfaces, sealing edges or sealing lips may be arranged. FIG. 2A shows the seam with the welding seam 10. Due to the scale, the course of the welding seam 10 and of the seam is not clearly visible.

The seal 2 illustrated in FIGS. 2A to 2D is particularly suitable for sealing pressurized cavities as they occur, for example, in engines and turbochargers, as well as in process engineering and power plant engineering. The seal 2 illustrated in FIGS. 2A to D is shaped similar to a bicycle tire or a car tire, i.e., it essentially corresponds to a toroidal surface that is cut open on the inside.

FIG. 2B shows a detailed view of the seal 2 at the seam 8 featuring the welding seam 10. The welding seam 10 is arranged on the outer side 12 of the seal. The detailed view clearly shows that the welding seam 10 or welding bead ends before the sealing area (the sealing edge or sealing surface) 6 at the inner boundary 18′ of the seal. Since the welding seam 10 does not extend into the sealing area 6, no material changes such as recrystallizations or the like that may negatively affect the sealing area 6 can occur at this location.

FIG. 2C shows a sectioned view of the seal 2 according to FIGS. 2A and B, with the line of section extending along the seam 8. Due to the oblique view, the inner side 4 of the seal and the outer side 12 of the seal are visible. The edges 20 of the seal that are directed (radially) inward are illustrated particularly well in the horizontal projection. The sectioned view elucidates that the welding seam ends before the inner boundary 18′ of the sealing area of the seal 2. Due to the section, not only the externally visible part of the welding seam 10 is illustrated in this figure, but also the part of the welding seam 10 that connects the two end faces abutting at the seam. The embodiment according to FIG. 2C also shows, in particular, that the welding seam 10 does not connect the entire seam. This figure shows that the seam 8 is unwelded on both sides, i.e., on the inner side 4 and on the outer side 12, and therefore over the entire thickness of the seam 8 in the sealing area 6.

FIG. 2D shows an enlarged detailed view of FIG. 2C. FIG. 2D shows the course of the welding seam 10 in the region of the seam 8. The welding seam 10 is externally produced on the outer side 12 of the seal 2. The welding seam 10 does not extend over the entire thickness of the seal because the seal could otherwise distort significantly during the welding process. However, it should be noted that a second welding seam can be produced on the inner side 4 of the seal in another production step. The welding seam ends before the inner boundary 18′ of the sealing area such that it does not extend into the sealing area 6. The sealing area 6 can be realized by means of roll-sizing, milling, grinding or polishing.

In order to prevent unnecessarily complicated drawings, the embodiments are not illustrated with different surface coatings.

FIG. 3 shows a partially sectioned side view of an inventive embodiment, in which the sealing area is not arranged directly on the edge of the seal. In this case, the sealing areas 6 of the seal are realized in the form of adjacently arranged beads. The sealing areas 6 are respectively spaced apart from one another and from the edges 20 of the seal. The sealing areas 6 are defined by boundaries, of which only the inner boundary 18′ is respectively illustrated due to the chosen perspective.

In contrast to the embodiment illustrated in the other figures, the seam is welded by means of welding seams 10 on both sides of the sealing areas. At the seam, the seal is connected on both sides, i.e., the inner side 4 and the outer side 12, by means of welding seams 10. The seam only remains unwelded in the region of the sealing areas 8 and no welding seams 10 extend in the sealing areas. However, welding seams 10 may extend between the boundaries of two different sealing areas 6. The seal illustrated in FIG. 3 is also respectively welded in the region between the sealing areas 6 and the edges 20 in order to reinforce the sealing areas. The terms outer side 12 and inner side 4 can only be used conditionally with reference to the embodiment shown in FIG. 3. The side of the seal that is predominantly in contact with an outer area was referred to as the outer side 4. The side of the seal that can be predominantly assigned to an inner area was referred to as the inner side 4.

It should also be noted that sealing areas in the form of the beads shown in FIG. 3 can also be subsequently processed by means of roll-sizing, milling or grinding in additional steps.

It should furthermore noted that the present invention also makes it possible to realize seals with several sealing areas that are designed differently and composed of the components of the embodiments illustrated in the figures.

### LIST OF REFERENCE SYMBOLS

2 Seal

4 Inner side of seal

6 Sealing area, sealing edge or sealing surface

8 Gap, joint, seam

10 Welding seam

12 Outer side of seal

16 Unwelded part of seal in sealing area

18 Outer boundary of a sealing area (in the radial direction)

18′ Inner boundary of a sealing area (in the radial direction)

20 Edge of seal

1. A metallic seal with a seam, wherein the metallic seal features at least one sealing area that is respectively defined by a boundary on two sides and serves for contacting at least one corresponding sealing surface in a sealing fashion, wherein the seam is provided with at least one welding seam extending outside the boundaries of the at least one sealing area only such that the metallic seal is unwelded at the seam between the boundaries of the at least one sealing area over the entire thickness of the seam.

2. The metallic seal according to Claim 1, including at least one bead.

3. The metallic seal according to Claim 1. wherein the metallic seal essentially has the shape of a cylinder jacket.

4. The metallic seal according to Claim 3, wherein the cylinder jacket is bent in the shape of a barrel.

5. The metallic seal according to Claim 3, wherein the cylinder jacket is tapered.

6. The metallic seal according to Claim 1, wherein the metallic seal is provided with a surface coating.

7. The metallic seal according to Claim 1, wherein the metallic seal is provided with a surface coating at least between the boundaries of the at least one sealing area.

8. The metallic seal according to Claim 6, wherein the surface coating comprises a solder.

9. The metallic seal according to Claim 1, wherein the metallic seal forms at least one bellow.

10. The metallic seal according to Claim 1, wherein the at least one welding seam consists of a laser welding seam.

11. The metallic seal according to Claim 1, wherein the at least one welding seam is produced on one side.

12. The metallic seal according to Claim 1, wherein the at least one welding seam is produced on two sides.

13. The metallic seal according to Claim 1, wherein the at least one seam is profiled.

14. The metallic seal according to Claim 1, wherein the at least one seam is at least partially inclined relative to the metallic seal.

15. The metallic seal according to Claim 1, wherein the part of the at least one seam of the at least one sealing area, into which the at least one welding seam does not extend, is compressed by forces that originate from the adjacent welding seam.

16. The metallic seal according to Claim 1, wherein the part of the at least one seam of the at least one sealing area, into which the welding seam does not extend, is compressed by forces that act upon the seal in the installed state.

17. The metallic seal according to Claim 1, wherein the at least one welding seam is produced on the side of the seal, on which the at least one sealing area is also arranged.

18. The metallic seal according to Claim 1, wherein there are at least two sealing areas that are respectively defined by associated said boundaries, wherein each welding seam extends outside the boundaries of the two sealing areas only such that the metallic seal is respectively unwelded at the seam between the boundaries of the two sealing areas over the entire thickness.

19. The metallic seal according to Claim 1, wherein at least one of the sealing areas is arranged on an edge of the seal.

20. The metallic seal according to Claim 19, wherein the metallic seal is unwelded at the seam from the sealing area up to the edge over the entire thickness.

21. The metallic seal according to Claim 19, wherein the seam is welded between the boundary of the sealing area and the edge.

22. A method for producing a metallic seal comprising
providing a semi-finished band or wire material,
cutting the semi-finished band or wire material into at least one blank such that each blank features end regions,
shaping at least one blank such that at least two end regions abut one another, and
shaping the blanks such that at least one sealing area is defined by boundaries, and
welding the blanks into a seal such that at least one welding seam extends outside the boundaries of a sealing area only and the seam of the metallic seal remains unwelded between the boundaries of a sealing area.

23. The method for producing a metallic seal including
roll-sizing of at least the sealing area.
